(19) United States
(12) Patent Application Publication
(10) Pub. No.: US 2024/0319214 A1
(43) Pub. Date: Sep. 26, 2024

(54) METHOD FOR CONTROLLING A MEASURING DEVICE AND MEASURING DEVICE

(71) Applicant: NETZSCH-Gerätebau GmbH, Selb (DE)

(72) Inventors: Martin BRUNNER, Konradsreuth (DE); Thomas DENNER, Selb (DE); Thilo HILPERT, Selb (DE); Fabian WOHLFAHRT, Rehau (DE); Michael SCHÖNEICH, Selb (DE); Michael MÜLLER, Trabitz (DE); Thorsten HACHMANN, Thierstein (DE)

(21) Appl. No.: 18/609,231

(22) Filed: Mar. 19, 2024

Related U.S. Application Data
(60) Provisional application No. 63/453,486, filed on Mar. 21, 2023.

(30) Foreign Application Priority Data
Mar. 21, 2023 (DE) 102023107046.0

(51) Int. Cl. G01N 35/00

(52) U.S. Cl. CPC G01N 35/00584

(57) ABSTRACT

A method for controlling a measuring device includes selecting a sample to be examined, creating conditions under which the sample is to be examined by the measuring device, and establishing measured values regarding properties of the sample, wherein the method steps are autonomously controlled by a controller. A measuring device is disclosed for performing the method.

### TECHNICAL FIELD

The disclosure herein relates to a method for controlling a measuring device and to a measuring device.

### BACKGROUND

The determination of properties of different materials is of major importance for many applications in research and industry. For this purpose a variety of measuring devices are used which, depending on the application, sometimes provide very complex measuring processes.

Performing these measurements by a user requires a certain level of expertise, since ensuring the successful completion of the desired measurement involves taking into account the technical and scientific background of the individual measurement processes. Furthermore, in most laboratory environments, measuring devices are used by several users or are used for a series of measurements directly one after another.

This makes it necessary to plan in advance which measurements are to be performed, as the measuring device may need to be set again between different measurements. If unforeseen events occur during a measurement, it can sometimes be time-consuming to change the predetermined plan, for example to repeat measurements or schedule new measurements. In particular, the physically missing of users, for example at night, can as a result negatively affect the efficiency of the utilization of the individually measuring devices.

### SUMMARY

Against this background, it is the object of the disclosure herein to design the use of measuring devices in a more efficient manner.

This task is solved by a method and by a measuring device having features disclosed herein.

Accordingly, a method for controlling a measuring device is provided. The method comprises selecting a sample to be examined, creating conditions under which the sample is to be examined by the measuring device, and establishing measured values regarding properties of the sample. The method steps are autonomously controlled by a controller.

Furthermore, a measuring device is provided which is configured to perform the method according to the disclosure herein.

It is an underlying idea of the disclosure herein to automate a measuring device as autonomously as possible by the controller. As a result, users of the measuring device are relieved of some of the workload, as fewer steps of the measuring process are prepared or performed personally. The disclosure herein also makes it possible to increase the efficiency of the measuring device at times when there are no physical users on site.

According to an example embodiment of the method, the controller autonomously selects the sample to be examined. As a result, users of the measuring device are further relieved. In particular, as a result, the measuring device can also perform measurements without the physical user being on site.

According to a further development of the method, the controller selects the sample to be examined based on conditions established at an earlier time by the measuring device. As a result, the efficiency of the measuring device can be increased, for example, by examining samples that are examined under identical or similar conditions one after another.

According to a further development of the method, the controller selects the sample to be examined based on measured values established at an earlier time by the measuring device. As a result, the measuring device can react advantageously to the results of individual measurements.

According to an example embodiment, the method further comprises repeating the process of establishing the measured values when it is detected by the controller that the measured values established are outside a plausible range. As a result, measurements that appear to be incorrect can be compensated advantageously without creating an additional burden for the user.

According to an example embodiment of the method, the controller accesses a database. The control of the measuring device can be advantageously supported by a suitable configuration of the database.

According to a further development of the method, the database comprises a plurality of information on material properties and measurement methods, with the controller autonomously controlling the measuring device based on this plurality of information. As a result, the controller can advantageously support a plurality of hypothetically possible measurements.

According to an example embodiment of the method, the controller updates the database after establishing the measured values. As a result, knowledge gained during a measurement can be used to advantage for future measurements.

### BRIEF DESCRIPTION OF THE DRAWINGS

The disclosure herein is explained below with reference to the figures of the drawings. In the figures:

FIG. 1 is a schematic flow diagram for a method according to an example embodiment of the disclosure herein;

FIG. 2 is a schematic representation of a measuring device according to an example embodiment of the disclosure herein; and

FIG. 3 is a schematic representation of a system with a plurality of measuring devices according to an example embodiment of the disclosure herein.

In the figures, the same reference signs designate identical or functionally identical components, unless indicated to the contrary.

### DETAILED DESCRIPTION

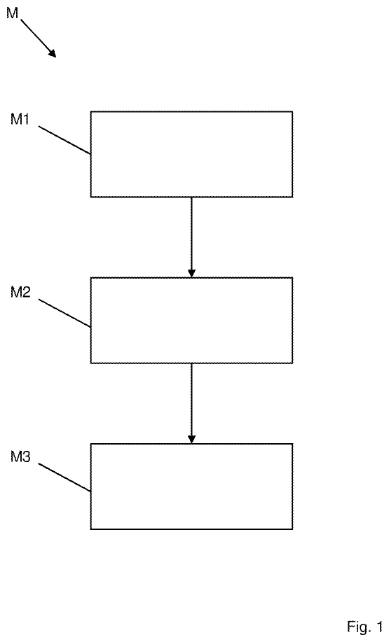

FIG. 1 shows a schematic flow diagram for a method M for controlling a measuring device according to an example embodiment of the disclosure herein.

In a first method step M1, a sample to be examined is selected. In a further method step M2, there are created conditions under which the sample is to be examined by the measuring device. In a further method step M3 there are established measured values regarding the properties of the sample. The method steps are autonomously controlled by a controller.

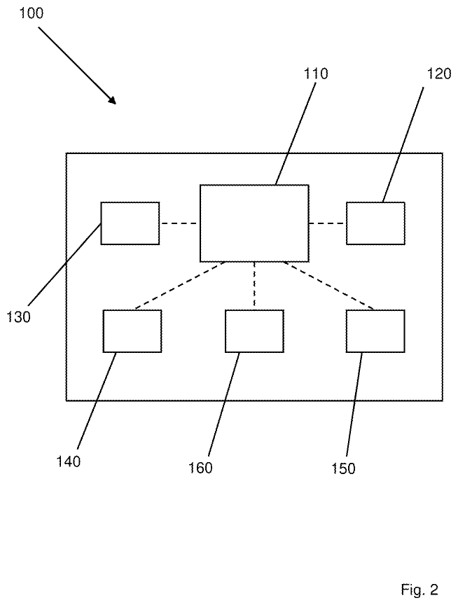

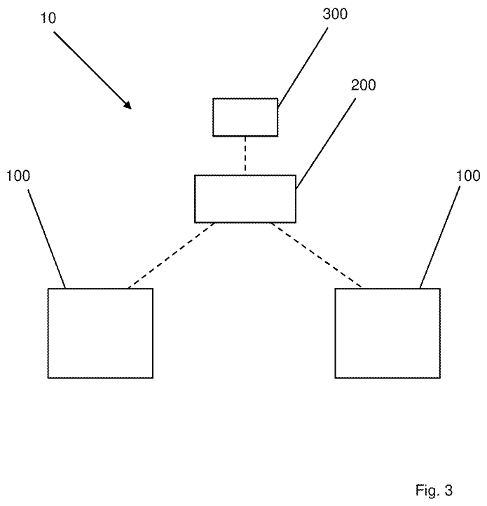

The method M shown is described in detail below with reference to FIGS. 2 and 3.

FIG. 2 shows a schematic representation of a measuring device 100 according to an example embodiment of the disclosure herein.

The measuring device 100 comprises a controller 110, a database 120, a sensor device 130, an outputting device 140, an inputting device 150, and a sample receiving device 160.

In the example embodiment shown here, the controller 110 is integrated in the measuring device 100 and can be configured to autonomously select a sample to be examined. For this purpose, both conditions established at an earlier time by the measuring device 100 and measured values established at an earlier time by the measuring device 100 can be taken into account. If the conditions required for examining one sample are also required for examining another sample, for example, it may be advantageous to examine these two samples in successive measurements, as a result of which the utilization of the measuring device 100 can be made more efficient.

Alternatively or additionally, the sample to be examined can also be selected by a user of the measuring device 100, who passes this selection to the controller 110. This selection can be transmitted by the user of the measuring device 100 to the controller 110, for example via the inputting device 150 of the measuring device 100. The inputting device 150 may comprise, for example, a keyboard, a touch screen or the like. Alternatively, the selection can also be transmitted to the controller 110 via an external interface.

The measuring device 100 is further configured to create conditions under which the sample is to be examined. In particular, this is autonomously controlled by the controller 110. In particular, the sample receiving device 160 can be configured accordingly for this purpose and can, for example, have components such as temperature controllers, voltage sources, gripper arms, conveyor belts or the like.

The measuring device 100 is further configured to establish measured values regarding properties of the sample. For this purpose, the sensor device 130 may be used, which may have the corresponding sensors, such as temperature measuring devices, current measuring devices, voltage measuring devices, force measuring devices or the like. These sensors or the sensor device 130 may also be configured as sub-component(s) of the sample receiving device 160.

The measuring device 100, in particular the controller 110, may also be configured to repeat the establishing of the measured values when it is detected by the controller 110 that the measured values established are outside a plausible range. As a result, the measuring device 100 can detect the possibility of a measurement not having been performed correctly and repeat it in order to confirm this possibility or to be able to establish correct measured values.

The controller 110 may be configured to access the database 120 for controlling the measuring device 100, which in the present example embodiment is configured in the form of an internal memory of the measuring device 100. The database 120 can comprise a plurality of information on material properties and measurement methods. In this case, the controller 110 autonomously controls the measuring device 100 based on this plurality of information.

The measuring device may further be configured to output the measured values established regarding the properties of the sample to a user of the measuring device 100. For example, the outputting device 140 of the measuring device 100 can be used for this purpose. The outputting device 140 may comprise, for example, a screen and/or speakers for this purpose. For example, the outputting device 140 and the inputting device 150 may also be combined in a touchscreen. Alternatively or additionally, individually components of the measuring device 100, such as the inputting device 150 and the sample receiving device 160, can also be highlighted, for example by illuminating switch fields to be actuated or the like.

In particular, the controller 110 may also be configured to update the database 120 after the measured values have been established. The measurement results relating to the material properties of the sample used in the measurement can then be recorded in the database 120, for example, and are then available for future measurements and measurement schedules. The information required for this regarding the measurement performed can either be transmitted to the controller 110 by a user of the measuring device 100. Alternatively or additionally, the controller 110 can also receive the relevant information directly from the measuring device 100, in particular from the sensor device 130.

The measuring device 100 can be configured in particular as a device for the thermal analysis of materials. In particular, the measuring device 100 may be configured to perform differential thermal analyses, dynamic differential calometry, dynamic mechanical analyses, thermomechanical analyses or the like. During such measuring processes, the support of a user by the controller 110 can be particularly advantageous.

FIG. 3 shows a schematic representation of a system 10 with a plurality of measuring devices 100 according to an example embodiment of the disclosure herein.

In the example embodiment shown, the system 10 comprises a total of two measuring devices 100, a controller 200 and a database 300.

The individually components of the system 10 can in principle be configured in exactly the same way as the corresponding components described with reference to FIG. 2. Only the controller 200 and the database 300 are configured as independent devices external to the two measuring devices 100 in the example embodiment shown here. In principle, however, the database 300 can also be configured as a sub-component of the controller 200.

Since the controller 200 is configured as a stand-alone device, it can be configured for use with either of the two measuring devices 100. This also makes it possible, for example, for a sample to be examined first by one of the measuring devices 100 and then examined completely autonomously by another measuring device 100. For this purpose there can be provided appropriate, not shown, means of transportation.

FIG. 3 shows two measuring devices 100. However, there can actually be provided any number of measuring devices 100. In particular, it may also be foreseen to use an individually measuring device 100 with an external controller 200 and/or an external database 300.

The measuring devices 100 can be configured to have the same function or be configured to perform different measurements in each case. Depending on the application, this allows the respective measurement processes to be performed simultaneously or sequentially.

The database 300 is shown here as a specific component of the system 10. However, it is also conceivable that the controller 200 and/or the database 300 is connected to an extended network, in particular to the Internet, and obtains relevant information directly via this network instead of storing it locally.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 measuring device
110 controller
120 database
130 sensor device
140 outputting device
150 inputting device
160 sample receiving device
200 controller
300 database
M method
M1 method step
M2 method step
M3 method step

1. A method for controlling a measuring device comprising:
selecting a sample to be examined;
creating conditions under which the sample is to be examined by the measuring device; and
establishing measured values regarding properties of the sample;
wherein the method steps are autonomously controlled by a controller.

2. The method according to claim 1, wherein the controller autonomously selects the sample to be examined.

3. The method according to claim 2, wherein the controller selects the sample to be examined based on conditions established at an earlier time by the measuring device.

4. The method according to claim 2, wherein the controller selects the sample to be examined based on measured values established at an earlier time by the measuring device.

5. The method according to claim 1, further comprising repeating the establishing of the measured values when it is detected by the controller that the established measured values are outside a plausible range.

6. The method according to claim 1, wherein the controller accesses a database.

7. The method according to claim 6, wherein the database comprises a plurality of information about material properties and measurement methods, and wherein the controller controls the measuring device autonomously based on the plurality of information.

8. The method according to claim 6, wherein the controller updates the database after establishing the measured values.

9. A measuring device configured to perform the method according to claim 1.
